(19) United States
(12) Patent Application Publication
(10) Pub. No.: US 2008/0268691 A1
(43) Pub. Date: Oct. 30, 2008

(54) Securing device for a power supply adapter

(75) Inventor: Calvin Chen, Taipei (TW)

Correspondence Address: ELIZABETH CHIEN-HALE, 40087 MISSION BLVD. BOX 367, FREMONT, CA, 94539, US

(73) Assignee: Digitone Industrial Co., Ltd.

(21) Appl. No.: 11/796,934

(22) Filed: Apr. 28, 2007

(51) Int. Cl. H01R 4/48

(52) U.S. Cl. 439/345

(57) ABSTRACT

A securing device for a power supply adapter includes a first tube extending through a cap and having a cutout defined in two opposed sides of the first tube and a second tube extending from a bottom face of a plug to be rotatably received in and extended out of the first tube and having a stop axially formed on a free end of the second tube to correspond to and be received in the cutout when the second tube is received in the first tube and the stop abuts a bottom peripheral edge of the first tube when the second tube is rotated relative to the first tube such that engagement between the plug and the cap is secured.

### BACKGROUND OF THE INVENTION

1. Field of the Invention

The present invention relates to a securing device, and more particularly to a securing device for a power supply adapter to allow different plugs to be detachably and securely connected to the body of the power supply adapter.

2. Description of the Prior Art

Because businessmen travel a lot internationally, they often have difficulties using electrical appliances brought from home in foreign countries due to different socket regulations. Some countries have flat sockets and others have circular sockets. Because the electrical appliances have only one plug design fitted to the hometown requirements, it is quite difficult for the businessmen to use the electrical appliances without additional accessories. One of the accessories is the power supply adapter. It has two different sets of plugs to enable the user to plug in different sockets when the user is in a country where the socket design corresponds to one of the plugs in the power supply adapter. The currently available power supply adapter normally have two sets of plugs available for the user to plug in sockets of different configurations, one of which is provided with flat terminals and the other is provided with circular terminals. In order to secure the each plug on the power supply body, the conventional securing device includes a sliding track defined in the body and a snap plate formed on a bottom face of the plug so that when the plug is to be connected to the body, the combination of the snap plate and the sliding track is able to secure the plug on the body.

However, this kind of combination provides no locking mechanism to secure the plug on the body. Therefore, the plug may fall off the body during the application of the power supply adapter, which may cause a fire and is thus quite dangerous to the environment.

To overcome the shortcomings, the present invention tends to provide a novel securing device to mitigate the aforementioned problems.

### SUMMARY OF THE INVENTION

The primary objective of the present invention is to provide a securing device for a power supply adapter to enable each of the plugs on the power supply adapter to be plugged in sockets of different configurations.

Another objective of the present invention is that the securing device of the present invention includes a first tube extending through a cap of the power supply adapter and a second tube extending from a bottom face of the plug to be rotatably received in and extended out of the first tube, wherein the second tube has a stop formed on a free end of the second tube and the first tube has a cutout defined in two opposed side faces of the first tube. Therefore, after the second tube is extended into the first tube, the stop is received in the cutout and when the second tube is extended out of and rotated relative to the first tube, the stop engages with a peripheral edge of the first tube to securely lock the plug on top of the cap.

A further objective of the present invention is that the securing device includes a tapered side face formed on a peripheral edge of the plug to correspond to a snap plate stamped on the cap such that when the second tube which is received in the first tube is rotated relative to the first tube, the tapered side face forces the snap plate down in the cap and after the second tube is rotated for a predetermined angle, the snap plate returns to its position and is received in a receiving recess defined in a peripheral edge of the plug to further secure the position of the plug relative to the cap.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the securing device of the present invention;

FIG. 2 is an exploded perspective view of the securing device of the present invention from an angle different from that of FIG. 1;

FIG. 3A is a perspective view showing that the plug is rotated relative to the cap and the snap plate is depressed by the tapered side face of the plug;

FIG. 3B is a top plan view showing that after the plug is rotated relative to the cap, the stop is away from the cutout and the combination between the plug and the cap is secured;

FIG. 3C is a cross sectional view showing that the snap plate is first depressed and then returned to its original position;

FIG. 4A is a perspective view showing that the snap plate is returned to its original position after the receiving recess defined in the plug is aligned with he snap plate;

FIG. 4B is a top plan view corresponding to the structural relationship between the stop and the first tube;

FIG. 4C is a cross sectional view corresponding to the structural relationship in FIG. 4A; and

FIG. 5 is an exploded perspective view showing that the plug has different terminals.

### DETAILED DESCRIPTION OF THE PREFERRED EMBODIMENT

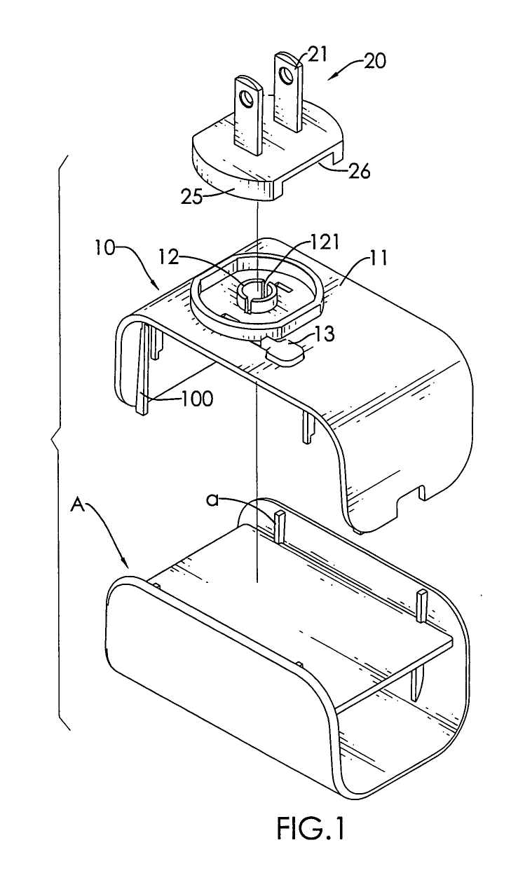

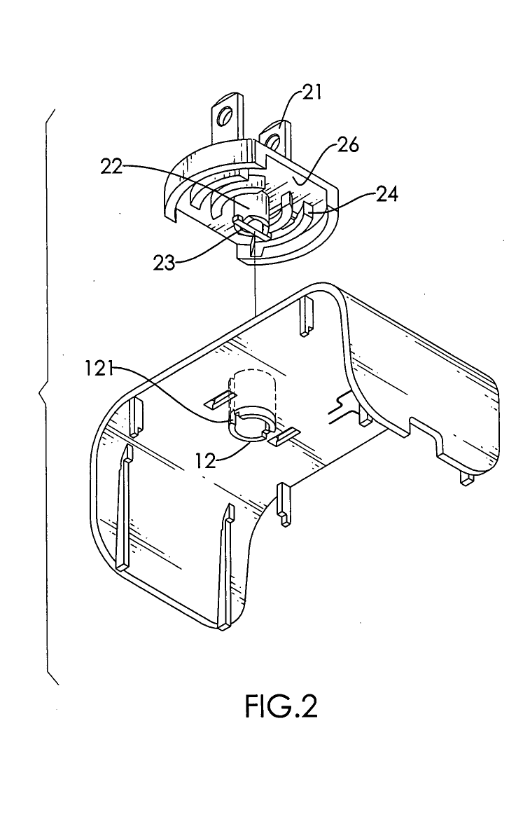

With reference to FIGS. 1 and 2, it is noted that a power supply adapter of the present invention includes a body (A), a cap (10) and a plug (20). The body (A) has two upright walls oppositely opposed to each other and each upright wall has multiple ribs (a) formed on an inner face of the upright wall. The cap (10) is substantially U shaped and has multiple sliding tracks (100) formed on an inner face of the cap (10) to correspond to the ribs (a) of the body (A). Therefore, the cap (10) is able to slidably connect to the body (A) with the ribs (a) received in the corresponding sliding tracks (100). However, the combination between the cap (10) and the body (A) is not the focus of the present invention. The focus lies on the structure to secure the plug (20) on top of the cap (10) after the cap (10) is secured to the body (A).

In order to accomplish the objective of securing the position of the plug (20) on top of the cap (10), the cap (10) is provided with a protruded ring (11) formed on a top face thereof, a first tube (12) extending through the cap (10) and a snap plate (13) stamped on the cap (10). The first tube (12) further has a cutout (121) defined in two opposed side faces of the first tube (12).

The plug (20) is provided with flat terminals (21), preferably two or three, extending upward therefrom, a second tube (22) extending downward from a bottom face thereof to correspond to and be received in the first tube (12), a stop (23) axially formed on a free end of the second tube (22) to correspond to the cutout (121) of the first tube (12), multiple sectioned arcuate walls (24) concentrically formed around the second tube (22) to correspond to the protruded ring (11) of the cap (10), a tapered side wall (25) formed on a peripheral wall thereof and a receiving recess (26) defined in a peripheral side wall adjacent to the tapered side face (25) to correspond to the snap plate (13).

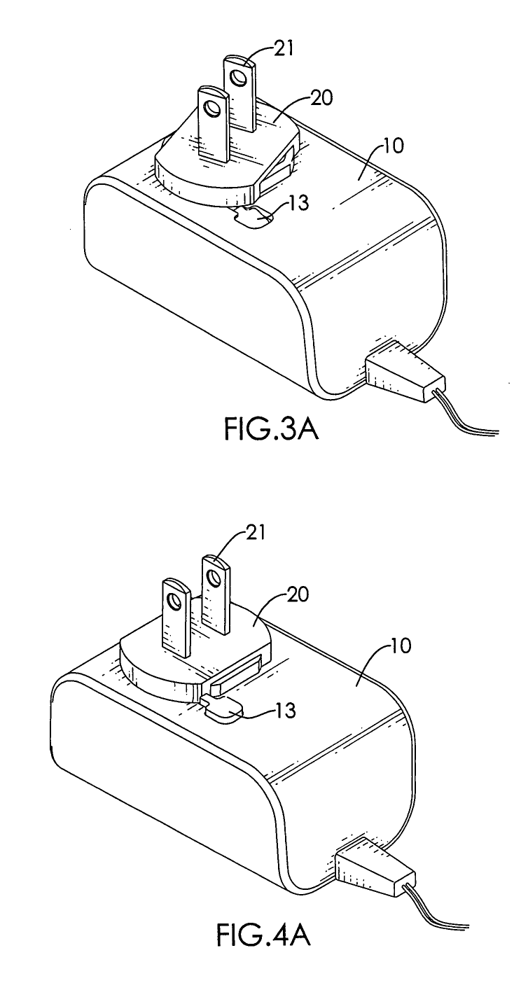

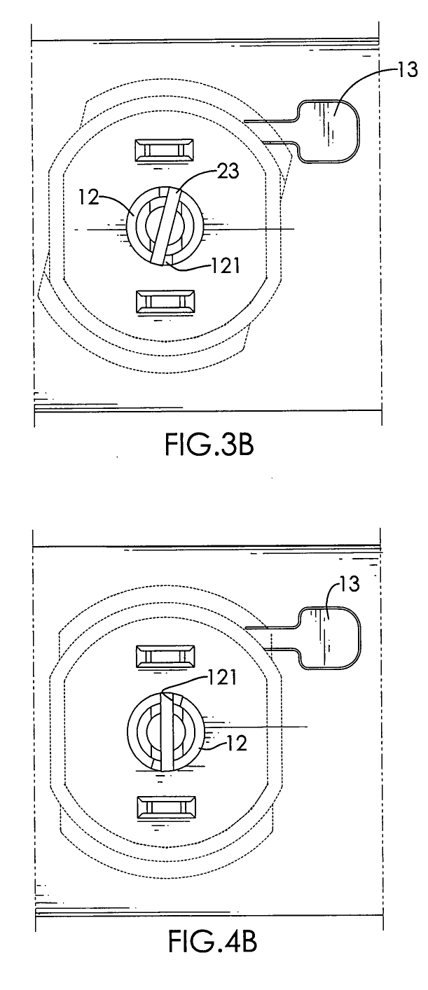

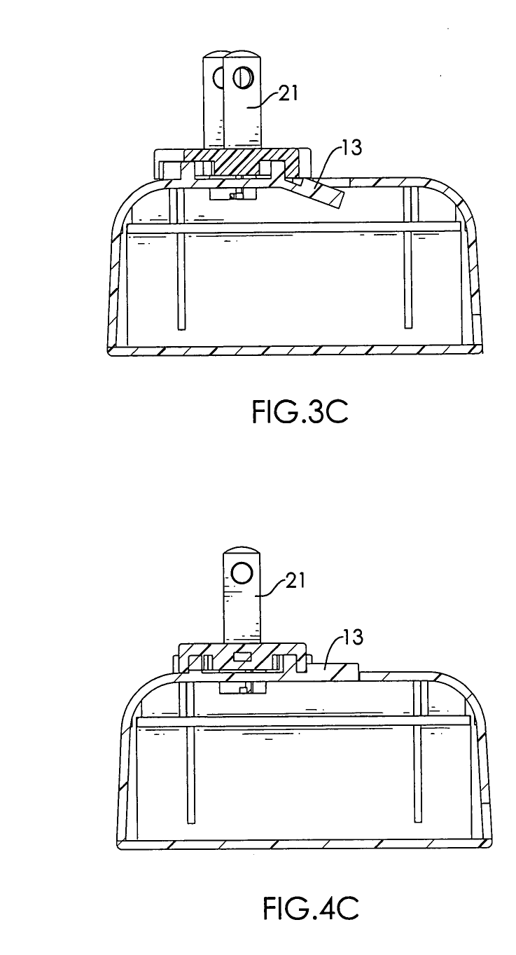

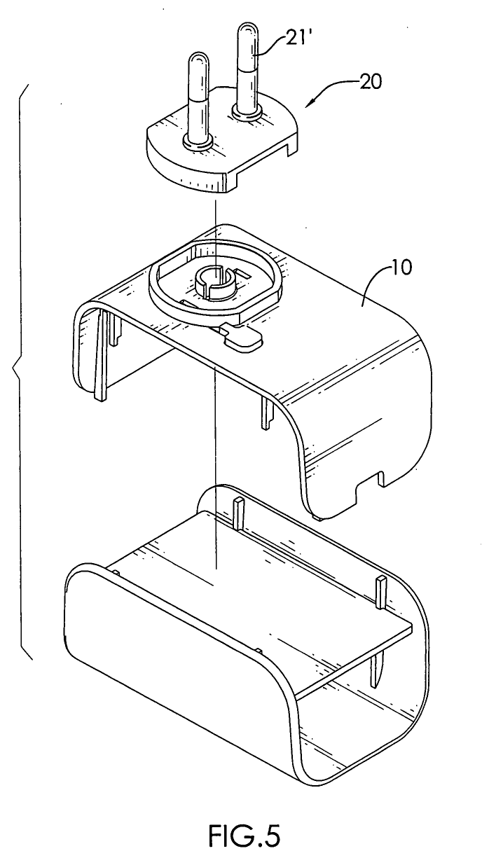

It is learned that the second tube (22) has a diameter smaller than that of the first tube (12) such that the second tube (22) is able to be received in the first tube (12). With reference to FIGS. 3A˜4C, when the second tube (22) is to be received in the first tube (12), the stop (23) is first received in the cutout (121) in the first tube (12). Thus when the second tube (22) is extending into the first tube (12) to be received in the first tube (12), the stop (23) is received in the cutout (121). After the second tube (22) extends out of the first tube (12), the stop (23) is also out of the first tube (12) and adjacent to a bottom free end of the first tube (22). Thereafter, rotation of the plug (20) relative to the cap (10) enables the stop (23) to abut the bottom free end of the first tube (12) to secure engagement between the plug (20) and the cap (10). When the stop (23) abuts the bottom free end of the first tube (12), the plug (20) is literally secured on top of the cap (10). In order to further secure the position of the plug (20) on top of the cap (10), continuous rotation of the plug (20) relative to the cap (10) allows the tapered side face (25) to first depress the snap plate (13) into the cap (10). Eventually, when the plug (20) is rotated to a position where the snap plate (13) is aligned with the receiving recess (26), the snap plate (13) is returned to its original position due to its own resilience force, which stops further rotation of the plug (20) relative to the cap (10) in either directions. Thereafter, the operator is able to use the power supply adapter safely and worries not about the fact that the plug (20) might fall of from the cap (10) during application of the power supply adapter.

With reference to FIG. 5, it is noted that the plug (20) has terminals (21′) having a configuration different from that shown in the first embodiment. Therefore, it is noted that the configuration of the terminals (21,21′) is not the issue, but how the engagement between the plug and the cap is secured is.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A securing device for a power supply adapter having a body, a cap detachably connected to the body and a plug connected to the cap, the securing device comprising:
a first tube adapted to be extending through the cap and having a cutout defined in two opposed sides of the first tube; and
a second tube adapted to be extending from a bottom face of the plug to be rotatably received in and extended out of the first tube and having a stop axially formed on a free end of the second tube to correspond to and be received in the cutout when the second tube is received in the first tube and the stop abuts a bottom peripheral edge of the first tube when the second tube is rotated relative to the first tube such that engagement between the plug and the cap is secured.

2. The securing device as claimed in claim 1 further comprising:
a snap plate adapted to be stamped on a side face of the cap;
a tapered side wall adapted to be formed on a peripheral wall of the plug and a receiving recess adapted to be defined in a peripheral side wall adjacent to the tapered side face of the plug to correspond to the snap plate to correspond to the snap plate so that the rotation of the plug relative to the cap not only helps to allow the stop to abut the peripheral edge of the first tube, but also allows the tapered side wall to first depress the snap ring until the snap plate is received in the receiving recess, which stops continuous rotation of the plug relative to the cap.

3. The securing device as claimed in claim 2 further comprising a protruded ring adapted to be formed on a top face of the cap and multiple sectioned arcuate walls adapted to be concentrically formed around the second tube of the plug to correspond to the protruded ring of the cap.
